(19) United States
(12) Patent Application Publication
(10) Pub. No.: US 2006/0017764 A1
(43) Pub. Date: Jan. 26, 2006

(54) Method and apparatus for controlling print head of image forming device using encoder

(75) Inventors: Kyung-pyo Kang, Suwon-si (KR); Hyoung-il Kim, Suwon-si (KR); Hwal-am Lee, Hwaseong-gun (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/167,466

(22) Filed: Jun. 28, 2005

(30) Foreign Application Priority Data
Jul. 26, 2004 (KR) 2004-0058345

(51) Int. Cl. B41J 29/393

(52) U.S. Cl. 347/19

(57) ABSTRACT

Provided are a method and an apparatus for controlling a print head of an image forming apparatus by using an encoder in which the operation of a motor is controlled by using an electrical signal attached to an idle roller and a period at which the print head prints an image on a printing medium is synchronized with the electrical signal. The method comprises converting the operation of the idle roller into an electrical signal by using the encoder and outputting the electrical signal, and controlling the print head so that the print head prints an image on the printing medium in response to the electrical signal.

### CROSS-REFERENCE TO RELATED APPLICATIONS

This application claims the benefit under 35 U.S.C. § 119(a) of Korean Patent Application No. 10-2004-0058345, entitled “METHOD AND APPARATUS FOR CONTROLLING PRINT HEAD OF IMAGE FORMING DEVICE USING ENCODER”, filed on Jul. 26, 2004, in the Korean Intellectual Property Office, the entire disclosure of which is hereby incorporated by reference.

### BACKGROUND OF THE INVENTION

1. Field of the Invention

The present invention relates to a method and apparatus for controlling a print head of an image forming apparatus. More particularly, the present invention relates to a method and apparatus for controlling a print head of an image forming apparatus using an encoder which controls the print head by using an output signal of the encoder attached to an idle roller.

2. Description of the Related Art

A thermal transfer image forming apparatus is an apparatus which forms an image by heating a thermal print head in an ink ribbon contacted to a printing medium and transferring ink onto the printing medium or forms an image by heating the thermal print head in a printing medium on which an ink layer that reacts with heat and represents a predetermined color is formed. The thermal print head heats the printing medium according to a predetermined time period.

In the above-described line printing image forming apparatus using the thermal print head or an ink-jet print head, when a printing operation is performed by heating the medium or ejecting ink from the print head at a predetermined time period regardless of a transfer speed of the printing medium, if a supply speed of the printing medium is changed by an external change such as a load change on the printing medium, a printing resolution cannot be exactly maintained.

### SUMMARY OF THE INVENTION

The present invention provides a method and apparatus for controlling a print head of an image forming apparatus using an encoder in which a time period at which the print head prints an image on a printing medium is synchronized with an encoder output signal attached to an idle roller such that a predetermined printing interval is maintained and an exact printing resolution is provided even when a printing medium input speed is changed by an external load change.

According to an aspect of the present invention, a method of controlling a print head of an image forming apparatus comprising a printing unit for printing an image on a printing medium, a driving roller for transferring the printing medium using a motor as a driving source, and an idle roller for engaging with the driving roller and rotating and supporting the printing medium is provided. The method comprises converting an operation of the idle roller into an electric signal using an encoder and outputting the electrical signal, and controlling the printing unit so that the printing unit prints an image on the printing medium in response to the electrical signal.

The printing unit may comprise a thermal print head for printing an image on the printing medium by heating the printing medium or an ink-jet print head for printing an image on the printing medium by ejecting ink from the print head.

The image forming apparatus controls the thermal print head so that the thermal print head heats the printing medium in response to the electrical signal, or controlling the ink-jet print head so that ink is ejected from the ink-jet print head onto the printing medium in response to the electrical signal.

According to another aspect of the present invention, a method of controlling a thermal print head of an image forming apparatus is provided. The image forming apparatus comprises the thermal print head for printing an image on a printing medium by heating the printing medium, a driving roller for transferring the printing medium using a motor as a driving source, and an idle roller for engaging with the driving roller and rotating and supporting the printing medium. The method comprises the steps of converting an operation of the idle roller into an electric signal using an encoder and outputting the electrical signal, and controlling the thermal print head so that the thermal print head heats the printing medium in response to the electrical signal.

The thermal print head may be rotated to face first and second sides of the printing medium and may print an image by heating the first and second sides of the printing medium.

The controlling of the thermal transfer head may comprise the steps of counting changes of the electrical signal, and if the counted number of changes of the electrical signal is a predetermined value, controlling the thermal print head so that the thermal print head heats the printing medium.

The changes of the electrical signal may be counted by using one of a rising edge and a falling edge of the electrical signal.

The method may further comprise controlling the motor in response to the electrical signal. The controlling of the motor may comprise the steps of setting a reference value of a motor speed for controlling the operation of the motor, and calculating the speed of the motor using the electrical signal per predetermined time, if the calculated speed of the motor is greater than the reference value, decreasing the speed of the motor, and if the calculated speed of the motor is less than the reference value, increasing the speed of the motor. According to still another aspect of the present invention, an apparatus for controlling a print head of an image forming apparatus is provided. The apparatus comprises a printing unit for printing an image on a printing medium, a driving roller for transferring the printing medium using a motor as a driving source, and an idle roller for engaging with the driving roller and rotating and supporting the printing medium. The apparatus further comprises an encoder for converting an operation of the idle roller into an electric signal and outputting the electrical signal, and a counter for counting changes of the electrical signal and whenever the number of the changes of the electrical signal is a predetermined value, generating a signal to start an image printing operation of the printing unit and outputting the signal.

The printing unit may comprise a thermal print head for printing an image on the printing medium by heating the printing medium.

The counter may calculate the changes of the electrical signal and whenever the number of the changes is a predetermined value, generate a signal to start the printing medium heating operation of the thermal print head or generate a signal to start an ink ejecting operation of the ink-jet print head and output the signal.

According to yet another aspect of the present invention, an apparatus for controlling a thermal print head of an image forming apparatus is provided. The image forming apparatus comprises the thermal print head for printing an image on a printing medium by heating the printing medium, a driving roller for transferring the printing medium using a motor as a driving source, and an idle roller for engaging with the driving roller and rotating and supporting the printing medium. The apparatus further comprises an encoder for converting an operation of the idle roller into an electric signal using an encoder and outputting the electrical signal, and a counter for counting changes of the electrical signal and whenever the number of the changes of the electrical signal is a predetermined value, generating a signal to start a printing medium heating operation of the thermal print head and outputting the signal.

The thermal print head may be rotated to face first and second sides of the printing medium and print an image by heating the first and second sides of the printing medium.

The changes of the electrical signal may be counted using one of a rising edge and a falling edge of the electrical signal.

The apparatus may further comprise a motor controller for controlling the motor using the electrical signal. The motor controller may comprise a reference value setting portion for setting a reference value of a motor speed for controlling the operation of the motor, a speed calculating portion for calculating a movement distance of the motor by counting edges of the electrical signal per predetermined time and calculating the speed of the motor by dividing the movement distance by a time taken for counting the edges and outputting the speed of the motor, and a controlling portion for increasing the speed of the motor when the reference value of the motor speed is greater than the motor speed output by the speed calculating portion and decreasing the speed of the motor when the reference value of the motor speed is less than the motor speed output by the speed calculating portion.

The method of controlling a print head of an image forming apparatus by using an encoder may be implemented by a computer readable recording medium on which a program for executing the method is recorded.

### BRIEF DESCRIPTION OF THE DRAWINGS

The above aspects and advantages of the present invention will become more apparent by describing in detail exemplary embodiments thereof with reference to the attached drawings in which:

FIG. 1 is a perspective view illustrating a thermal transfer image forming apparatus comprising an encoder attached to an idle roller according to an exemplary embodiment of the present invention;

FIG. 2 is a block diagram illustrating an apparatus for controlling a thermal print head by using an encoder according to an exemplary embodiment of the present invention;

FIG. 3 is a detailed block diagram illustrating a motor controller shown in FIG. 2 according to an exemplary embodiment of the present invention;

FIG. 4 is a flowchart illustrating a method of controlling a thermal print head by using an encoder according to an exemplary embodiment of the present invention;

FIG. 5 is a detailed flowchart illustrating the method shown in FIG. 4;

FIG. 6 is a diagram illustrating an encoder output signal comprising a square wave shape versus printing medium heating time of a thermal print head;

FIG. 7 is a diagram illustrating an encoder output signal comprising a sinusoidal wave shape versus printing time of a thermal print head;

FIG. 8 is a flowchart illustrating a method of controlling a motor by using an encoder attached to an idle roller;

FIG. 9 is a perspective view illustrating a bin-shaped ink-jet image forming apparatus comprising an encoder attached to an idle roller; and

FIG. 10 is a perspective view of a C path type ink-jet image forming apparatus comprising an encoder attached to an idle roller.

Throughout the drawings, it should be noted that like reference numbers are used to depict the same or similar elements, features and structures.

### DETAILED DESCRIPTION OF EXEMPLARY EMBODYMENTS

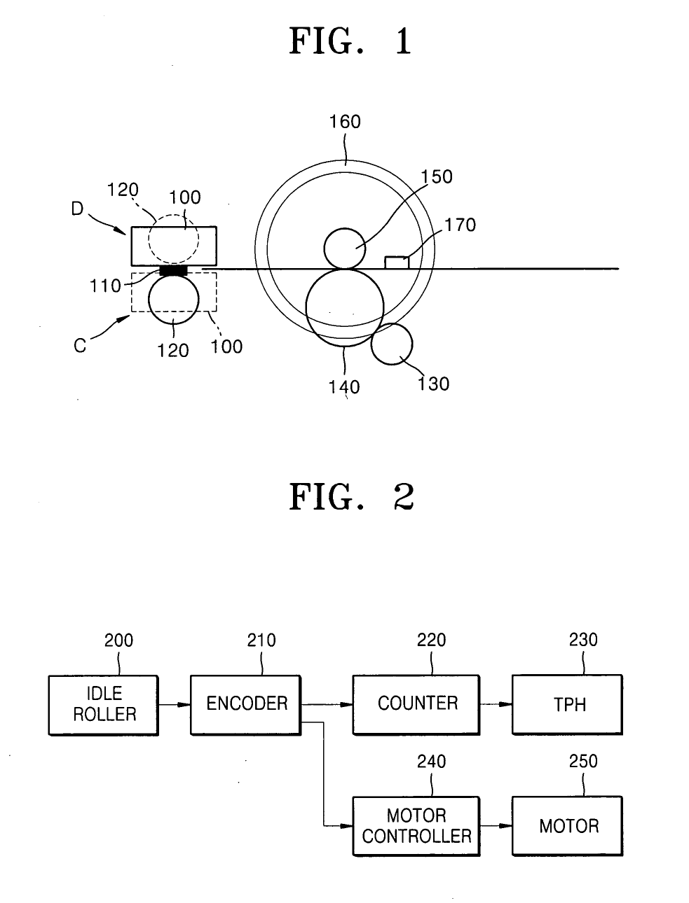

FIG. 1 is a perspective view illustrating a thermal transfer image forming apparatus comprising an encoder attached to an idle roller. The thermal transfer image forming apparatus of FIG. 1 comprises a thermal print head 100, a thermal print head nozzle 110, a platen roller 120, a motor 130, a driving roller 140, an idle roller 150, an encoder 160, and a media sensor 170.

The thermal print head 100 heats a printing medium at a predetermined heating time period. The thermal print head nozzle 110 supplies ink required for printing to the platen roller 120. The platen roller 120 supports the printing medium so that the printing medium is placed between the platen roller 120 and the thermal print head 100 and the platen roller 120 faces the thermal print head 100 and rotates by transfer of the printing medium.

The motor 130 is a driving source for supplying the printing medium to be printed on to the thermal print head 100, and the driving roller 140 engages with the motor 130 and rotates and transfers the printing medium. The idle roller 150 engages with the driving roller 140 and rotates and transfers the printing medium in the state where the printing medium is placed between the idle roller 150 and the driving roller 140. The encoder 160 is attached to the idle roller 150 and converts the operation of the idle roller 150 into an electrical signal and outputs the electrical signal. The media sensor 170 senses the position of the printing medium to be printed.

In order to print an image on the printing medium by using one thermal print head, the thermal print head 100 may perform a printing operation by heating first and second sides of the printing medium, respectively. For example, when an image printing operation is performed on the first side of the printing medium, the thermal print head 100 is placed in portion C, and when the image printing operation is performed on the second side of the printing medium, the thermal print head 100 rotates with the platen roller 120 to be placed in portion D.

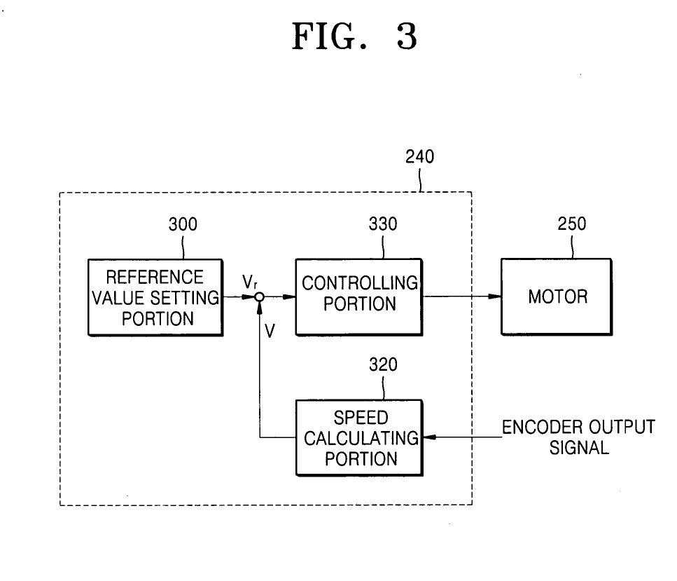

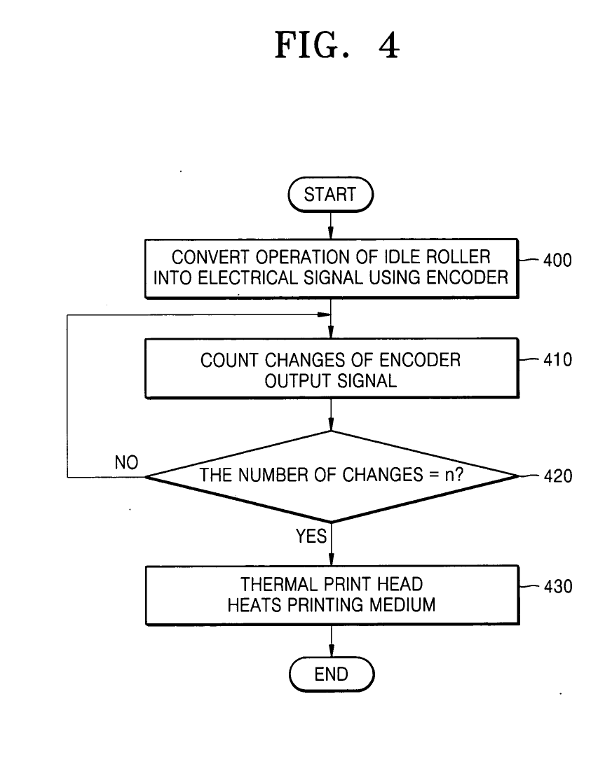

FIG. 2 is a block diagram illustrating an apparatus for controlling a thermal print head by using an encoder according to an exemplary embodiment of the present invention. The apparatus for controlling the thermal print head of FIG. 2 comprises an idle roller 200, an encoder 210, a counter 220, a thermal print head 230, a motor controller 240, and a motor 250. The apparatus of FIG. 2 will now be described with reference to the flowchart of FIG. 4.

The encoder 210 is attached to the idle roller 200 and converts the operation of the idle roller 200 into an electrical signal at step 400. The counter 220 counts the number of changes of an output signal of the encoder 210 at step 410 and compares the number of changes of the output signal of the encoder 210 with a heating period n at step 420. The heating period n is established to synchronize a heating time of the thermal print head 230 with the output signal of the encoder 210.

Whenever the number of changes reaches the heating time n, the counter 220 may output a heat signal to start to heat the thermal print head 230 and the thermal print head 230 heats the printing medium in response to the heat signal at step 430. The counter 220 counts a rising edge or falling edge of the output signal of the encoder 210 or a portion in which the output signal of the encoder 210 has a predetermined value, when the output signal of the encoder 210 has a square wave shape as a change of the output signal of the encoder 210. When the output signal of the encoder 210 has a sinusoidal wave shape, a portion in which the output signal of the encoder 210 has a maximum or minimum value may be counted.

The motor 250 is a driving source for supplying the printing medium to be printed on to the thermal print head 230 and the operation of the motor 250 is controlled by the motor controller 240.

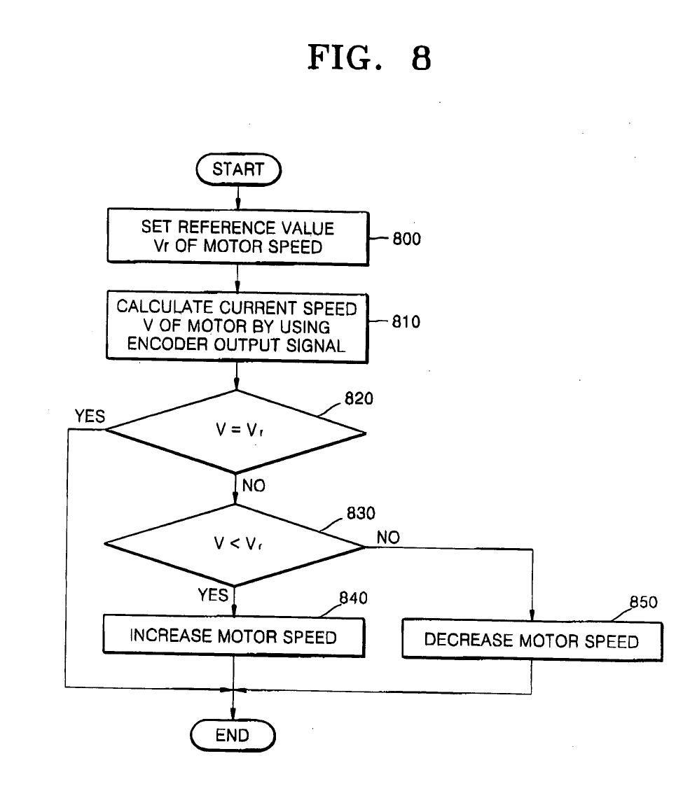

FIG. 3 is a detailed block diagram illustrating the motor controller 240 shown in FIG. 2 according to an exemplary embodiment of the present invention. The motor controller of FIG. 3 comprises a reference value setting portion 300, a motor 250, a speed calculating portion 320, and a controlling portion 330. The operation of the motor controller 240 shown in FIG. 3 will be described with reference to the flowchart of FIG. 8.

The reference value setting portion 300 establishes a reference value Vᵣ of a motor speed for controlling the operation of the motor 250 at step 800. The speed calculating portion 320 calculates a current speed V of the idle roller 220 by using an output signal of the encoder 210, that is, an electrical signal in which the operation of the idle roller 200 is converted by the encoder 210 at step 810.

The speed V is calculated by the following method. That is, changes of the output signal of the encoder 210 are counted, the number of changes counted per predetermined control period is multiplied by a unit distance at which the idle roller 200 rotates between changes of the output signal of the encoder 210, a movement distance of the idle roller 200 is calculated, and the calculated movement distance is divided by a time taken for counting the changes of the output signal of the encoder 210 so that the speed of the idle roller 200 is calculated. When the output signal of the encoder 210 has a square wave shape, the change of the output signal of the encoder 210 may be a rising edge or falling edge of the output signal of the encoder 210 or a portion in which the output signal of the encoder 210 has a predetermined value. When the output signal of the encoder 210 has a sinusoidal wave shape, the change of the output signal of the encoder 210 may be a portion in which the output signal of the encoder 210 has a maximum or minimum value.

The controlling portion 330 determines whether a reference value Vᵣ of the motor speed output from the reference value setting portion 300 is the same as the current speed V of the idle roller 200 outputs from the speed calculating portion 320 at step 820. If the controlling portion 330 compares the current speed V of the idle roller 200 with the motor speed reference value Vᵣ in a predetermined range of errors and the current speed V is in the range of errors, it may be determined that the current speed V of the idle roller 200 is the same as the motor speed reference value Vᵣ.

If the current speed V of the idle roller 200 is different from the motor speed reference value Vᵣ, the controlling portion 330 determines whether the current speed V of the idle roller 200 is less than the motor speed reference value Vᵣ at step 830. If the current speed V of the idle roller 200 is less than the motor speed reference value Vᵣ, the controlling portion 330 increases the amount of current supplied to the motor 250 so that the speed of the motor 250 increases at step 840. If the current speed V of the idle roller 200 is greater than the motor speed reference value Vᵣ, the controlling portion 330 decreases the amount of the current supplied to the motor 250 so that the speed of the motor 250 decreases. The controlling portion 330 may be a PID, PI, P, an adaptive controller or any other suitable control device.

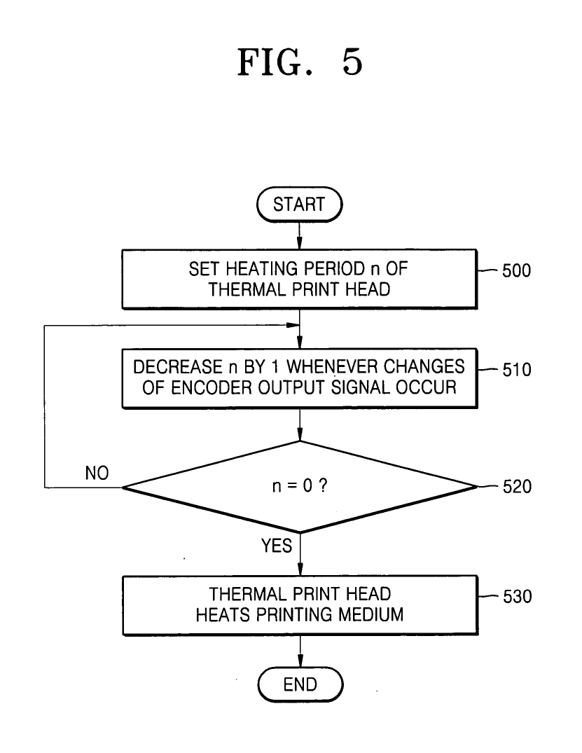

FIG. 5 is a detailed flowchart illustrating the method shown in FIG. 4. The heating period n at which the printing medium of the thermal print head 230 is heated is established at step 500. Changes of the output signal of the encoder 210 in which the operation of the idle roller 200 is converted into an electrical signal are sensed and n is decreased by 1 whenever the changes of the output signal of the encoder 210 occur at step 510. In this case, a down counter may be used.

It is determined whether n is equal to 0 at step 520. If it is determined that n is not equal to 0, the step 510 is repeatedly performed until n becomes 0. If it is determined that n is equal to 0, the thermal print head 230 heats the printing medium at step 530.

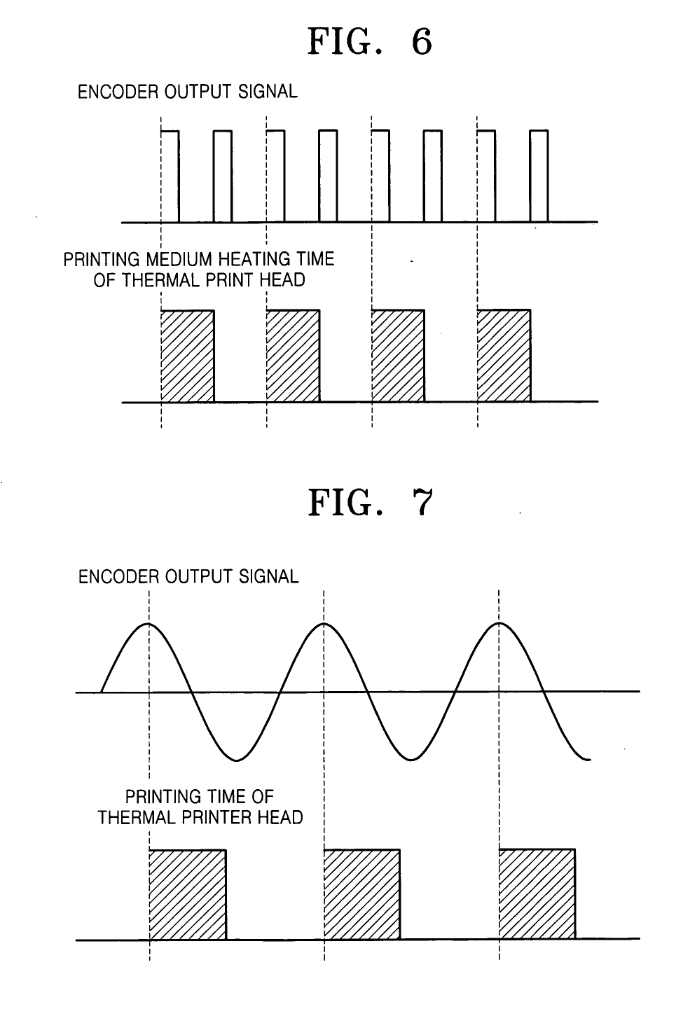

FIG. 6 is a diagram illustrating an encoder output signal comprising a square wave shape versus printing medium heating time of a thermal print head. In the graph shown in FIG. 6, the thermal print head 230 establishes the heating period to 2 and heats the printing medium whenever the number of rising edges of the output signal of the encoder 210 counted by the counter 220 is 2.

FIG. 7 is a diagram illustrating an encoder output signal comprising a sinusoidal wave shape versus printing time of a thermal print head. In the graph shown in FIG. 7, the thermal print head 230 establishes the heating period to 2 and heats the printing medium whenever the number of maximum or minimum values in which a differential value of the output signal of the encoder 210 counted by the counter 220 is 0 is 2.

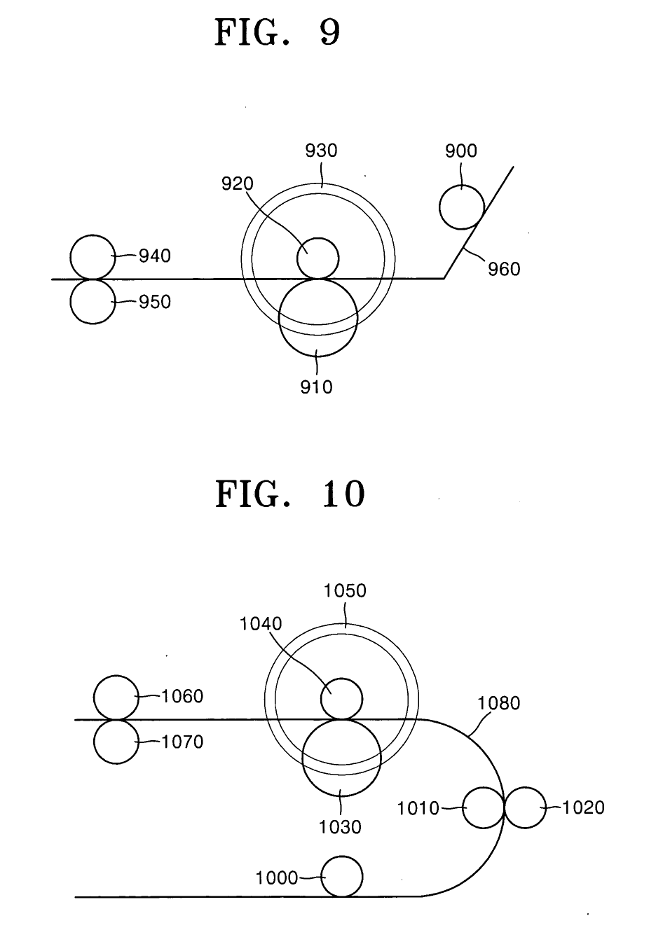

FIG. 9 is a perspective view illustrating a bin-shaped ink-jet image forming apparatus comprising an encoder attached to an idle roller. The apparatus of FIG. 9 comprises a pickup roller 900, a driving roller 910, an idle roller 920, an encoder 930, and discharging rollers 940 and 950.

The encoder 930 is attached to the idle roller 920 and converts the operation of the idle roller 920 into an electrical signal and outputs the electrical signal. An ink-jet print head (not shown) is synchronized with the encoder output signal and ejects ink to the printing medium. In addition, the operation of a motor (not shown) for driving the driving roller 910 may be controlled by using the output signal of the encoder 930.

FIG. 10 is a perspective view illustrating a C path type ink-jet image forming apparatus comprising an encoder attached to an idle roller. The apparatus of FIG. 10 comprises a pickup roller 1000, drive rollers 1010 and 1020, a driving roller 1030, an idle roller 1040, an encoder 1050, and discharging rollers 1060 and 1070.

The encoder 1050 is attached to the idle roller 1040 and converts the operation of the idle roller 1040 into an electrical signal and outputs the electrical signal. An ink-jet print head (not shown) is synchronized with the encoder output signal and ejects ink to the printing medium. In addition, the operation of a motor (not shown) for driving the driving roller 1030 may be controlled using the output signal of the encoder 1050.

Although the image forming apparatus using the thermal print head and the ink-jet image forming apparatus have been described, an apparatus for controlling a print head of an image forming apparatus by using an encoder according to an exemplary embodiment of the present invention can be applied to all line printing image forming apparatuses.

The invention can also be embodied as computer readable codes on a computer readable recording medium. The computer readable recording medium is any data storage device that can store data which can be thereafter read by a computer system. For example, the computer readable recording medium comprises read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion.

As described above, in the method and apparatus for controlling the print head of the image forming apparatus by using the encoder according to exemplary embodiments of the present invention, when a printing medium is transferred by using a motor as a driving source, a time period at which the print head prints an image on the printing medium is synchronized with an encoder output signal attached to an idle roller such that a predetermined printing interval is maintained and an exact printing resolution is provided even when a printing medium input speed is changed by an external load change. In addition, a movement speed of the printing medium is calculated by using the output signal of the encoder attached to the idle roller and changes of a motor speed is compensated in a real-time by using a controller such that the speed at which the printing medium is supplied is maintained.

While this invention has been particularly shown and described with reference to exemplary embodiments thereof, it will be understood by those skilled in the art that various changes in form and details may be made therein without departing from the spirit and scope of the invention as defined by the appended claims.

What is claimed is:

1. A method of controlling a print head of an image forming apparatus comprising a printing unit for printing an image on a printing medium, a driving roller for transferring the printing medium by using a motor as a driving source, and an idle roller for engaging with the driving roller and rotating and supporting the printing medium, the method comprising the steps of:
converting an operation of the idle roller into an electric signal using an encoder and outputting the electrical signal; and
controlling the printing unit so that the printing unit prints an image on the printing medium in response to the electrical signal.

2. The method of claim 1, wherein the printing unit comprises a thermal print head for printing an image on the printing medium by heating the printing medium.

3. The method of claim 2, wherein the controlling step comprises controlling the thermal print head so that the thermal print head heats the printing medium in response to the electrical signal.

4. The method of claim 1, wherein the printing unit comprises an ink-jet print head for printing an image on the printing medium by ejecting ink from the print head.

5. The method of claim 4, wherein the controlling step comprises controlling the ink-jet print head so that ink is ejected from the ink-jet print head onto the printing medium in response to the electrical signal.

6. A method of controlling a thermal print head of an image forming apparatus comprising the thermal print head for printing an image on a printing medium by heating the printing medium, a driving roller for transferring the printing medium by using a motor as a driving source, and an idle roller for engaging with the driving roller and rotating and supporting the printing medium, the method comprising the steps of:
converting an operation of the idle roller into an electric signal using an encoder and outputting the electrical signal; and
controlling the thermal print head so that the thermal print head heats the printing medium in response to the electrical signal.

7. The method of claim 6, wherein the thermal print head is rotated to face first and second sides of the printing medium and prints an image by heating the first and second sides of the printing medium.

8. The method of claim 6, wherein the controlling step comprises:
counting changes of the electrical signal; and
if the counted number of changes of the electrical signal is a predetermined value, controlling the thermal print head so that the thermal print head heats the printing medium.

9. The method of claim 8, wherein the changes of the electrical signal are counted by using one of a rising edge and a falling edge of the electrical signal.

10. The method of claim 6, further comprising controlling the motor in response to the electrical signal.

11. The method of claim 10, wherein the controlling step comprises:
establishing a reference value of a motor speed for controlling the operation of the motor; and
calculating the speed of the motor by using the electrical signal per predetermined time, if the calculated speed of the motor is greater than the reference value, decreasing the speed of the motor, and if the calculated speed of the motor is less than the reference value, increasing the speed of the motor.

12. An apparatus for controlling a print head of an image forming apparatus comprising a printing unit for printing an image on a printing medium, a driving roller for transferring the printing medium using a motor as a driving source, and an idle roller for engaging with the driving roller and rotating and supporting the printing medium, the apparatus comprising:
an encoder for converting an operation of the idle roller into an electric signal and outputting the electrical signal; and
a counter for counting changes of the electrical signal and whenever the number of the changes of the electrical signal is a predetermined value, generating a signal to start an image printing operation of the printing unit and outputting the signal.

13. The apparatus of claim 12, wherein the printing unit comprises a thermal print head for printing an image on the printing medium by heating the printing medium.

14. The apparatus of claim 13, wherein the counter calculates the changes of the electrical signal and whenever the number of the changes is a predetermined value, generates a signal to start the printing medium heating operation of the thermal print head.

15. The apparatus of claim 12, wherein the printing unit comprises an ink-jet print head for printing an image on the printing medium by ejecting ink from the print head.

16. The apparatus of claim 15, wherein the counter calculates the changes of the electrical signal and whenever the number of the changes is a predetermined value, generates a signal to start an ink ejecting operation of the ink-jet print head and outputs the signal.

17. An apparatus for controlling a thermal print head of an image forming apparatus comprising the thermal print head for printing an image on a printing medium by heating the printing medium, a driving roller for transferring the printing medium using a motor as a driving source, and an idle roller for engaging with the driving roller and rotating and supporting the printing medium, the apparatus comprising:
an encoder for converting an operation of the idle roller into an electric signal by using an encoder and outputting the electrical signal; and
a counter for counting changes of the electrical signal and whenever the number of the changes of the electrical signal is a predetermined value, generating a signal to start a printing medium heating operation of the thermal print head and outputting the signal.

18. The apparatus of claim 17, wherein the thermal print head is rotated to face first and second sides of the printing medium and prints an image by heating the first and second sides of the printing medium.

19. The apparatus of claim 17, wherein the changes of the output signal of the encoder are counted by using one of a rising edge and a falling edge of the electrical signal.

20. The apparatus of claim 17, further comprising a motor controller for controlling the motor using the electrical signal.

21. The apparatus of claim 20, wherein the motor controller comprises:
a reference value setting portion for establishing a reference value of a motor speed for controlling the operation of the motor;
a speed calculating portion for calculating a movement distance of the motor by counting edges of the electrical signal per predetermined time and calculating the speed of the motor by dividing the movement distance by a time taken for counting the edges and outputting the speed of the motor; and
a controlling portion for increasing the speed of the motor when the reference value of the motor speed is greater than the motor speed output by the speed calculating portion and decreasing the speed of the motor when the reference value of the motor speed is less than the motor speed output by the speed calculating portion.

22. A computer readable recording medium on which a program for executing the method of claim 1 is recorded.

23. A computer readable recording medium on which a program for executing the method of claim 6 is recorded.
